(19) United States
(12) Patent Application Publication
(10) Pub. No.: US 2011/0229542 A1
(43) Pub. Date: Sep. 22, 2011

(54) METHODS FOR IMPARTING ANTI-MICROBIAL, MICROBICIDAL PROPERTIES TO FABRICS, YARNS AND FILAMENTS, AND FABRICS, YARNS AND FILAMENTS EMBODYING SUCH PROPERTIES

(75) Inventors: Diana R. Cundell, Philadelphia, PA (US); Alexander A. Messinger, Ardmore, PA (US); Brian R. George, Pottstown, PA (US); Bhalchandra Dhamankar, Newark, DE (US); Ekaterina Shumilova, Perkasie, PA (US)

(73) Assignee: PHILADELPHIA UNIVERSITY, Philadelphia, PA (US)

(21) Appl. No.: 13/052,592

(22) Filed: Mar. 21, 2011

Related U.S. Application Data
(63) Continuation-in-part of application No. 12/705,843, filed on Feb. 15, 2010.
(60) Provisional application No. 61/316,110, filed on Mar. 22, 2010.
(60) Provisional application No. 61/351,390, filed on Jun. 4, 2010.

(51) Int. Cl. A01P 1/00; A01N 25/34; A01N 65/08; A01N 65/12; A01N 65/42; A01N 65/48; A01N 31/14; B05D 3/02; B05D 3/10; F24F 7/007

(52) U.S. Cl. 424/404; 424/737; 424/725; 424/744; 424/756; 424/764; 514/718; 427/381; 427/382; 454/254; 454/338

(57) ABSTRACT

An antimicrobial fabric and method for treating fabric to impart antimicrobial properties thereto by preparing an aqueous solution of eugenol, polyvinyl alcohol, and glyoxal, padding the fabric with the aqueous solution to achieve a preselected desired part by weight wet pickup, drying the fabric; and curing the fabric.

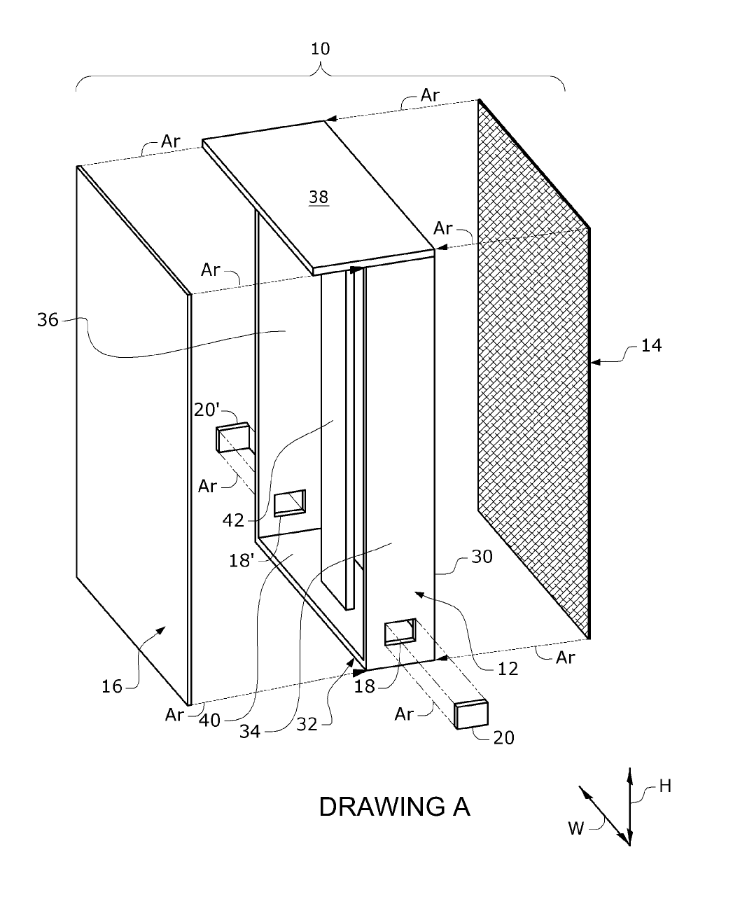

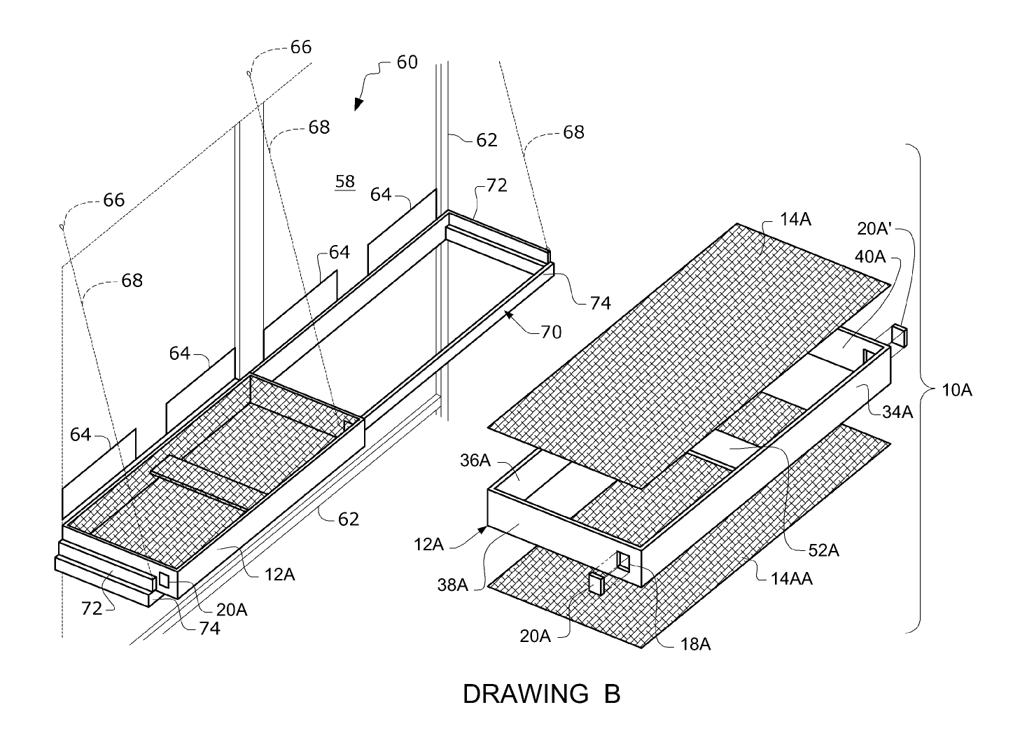

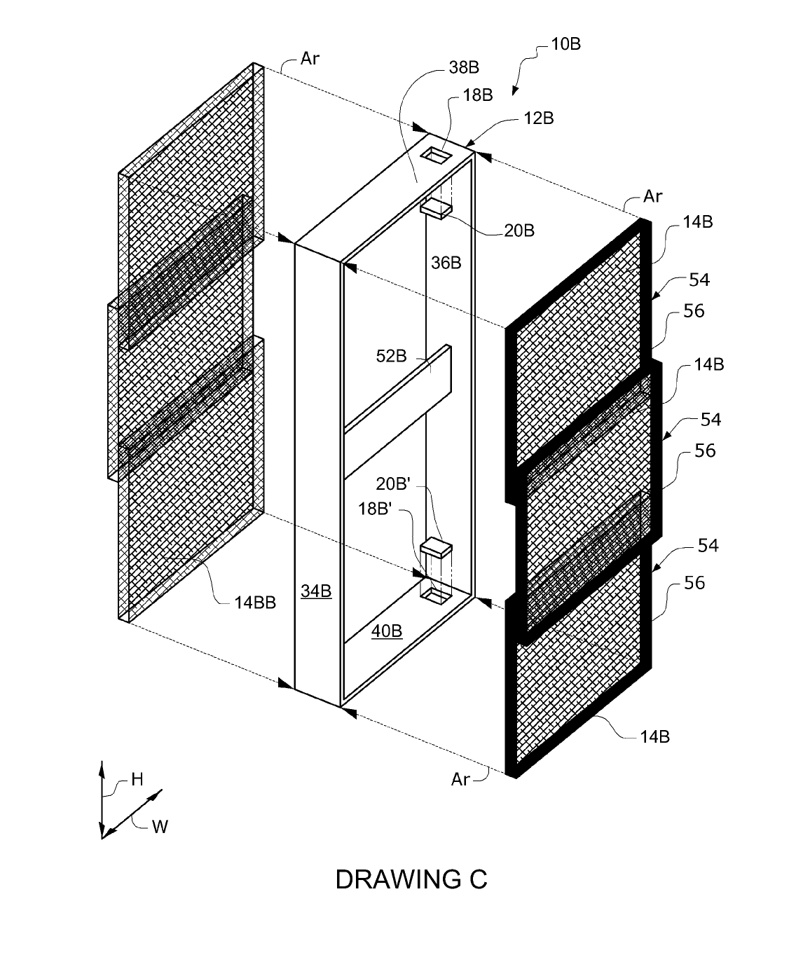

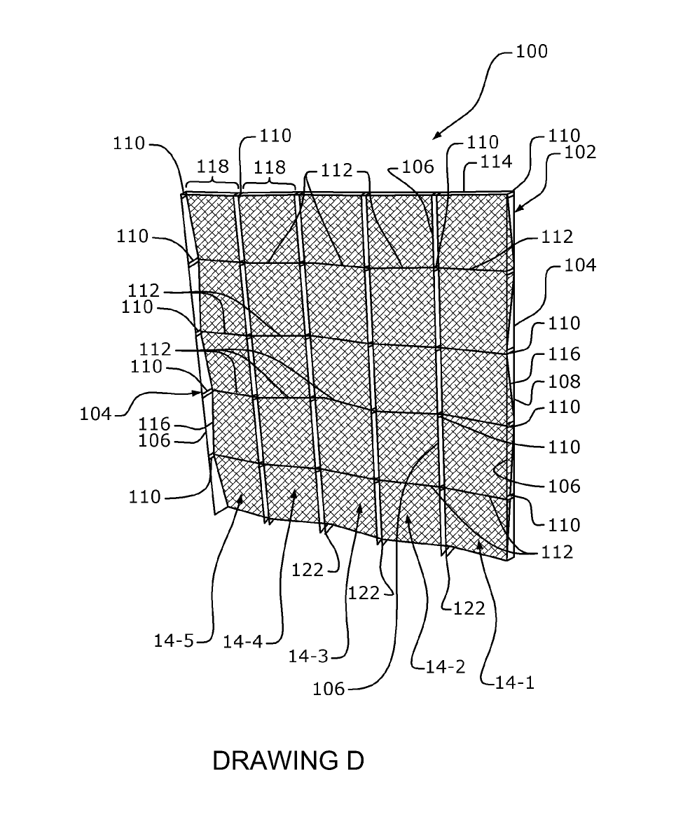

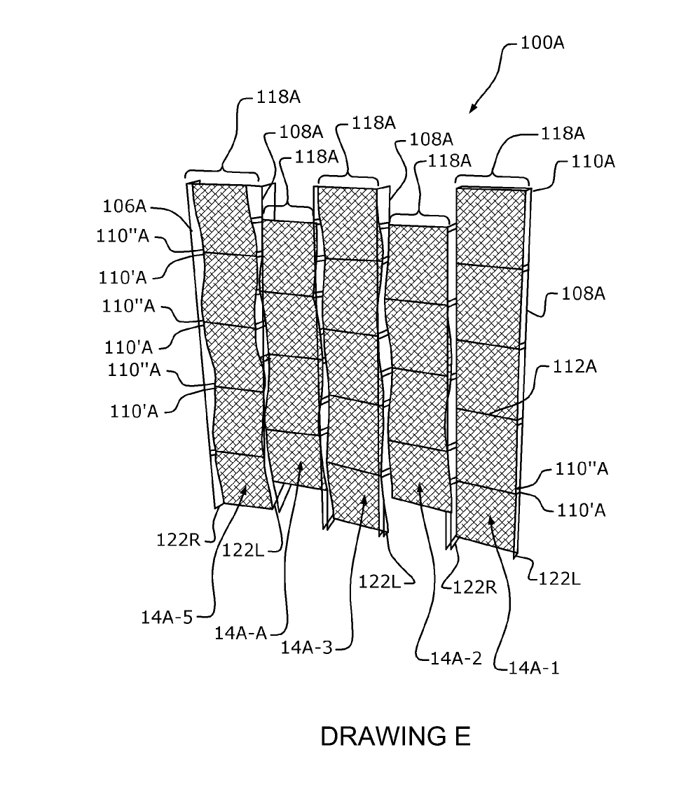

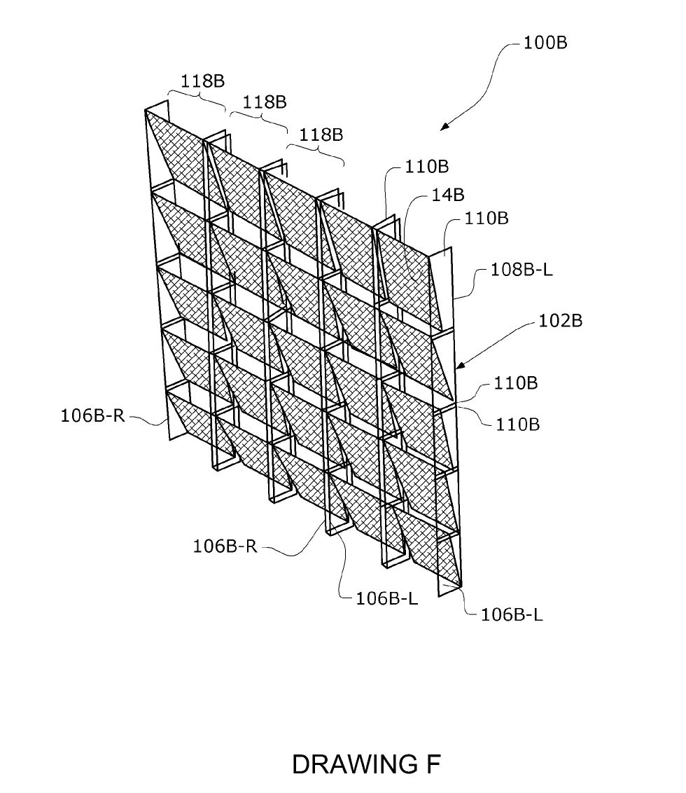

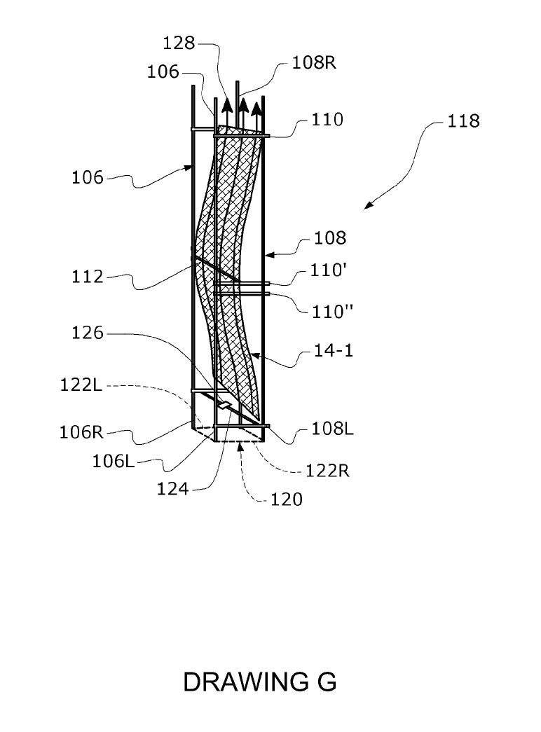

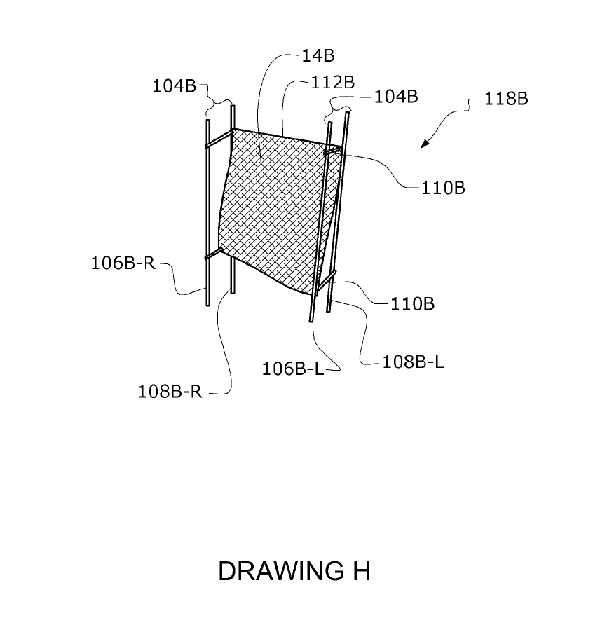

### CROSS-REFERENCE TO RELATED PATENT APPLICATIONS

This patent application claims the benefit of the priority of U.S. provisional application Ser. No. 61/316,110, filed 22 Mar. 2010 in the names of Alexander A. Messinger, Diana R. Cundell, Brian R. George, Bhalchandra Dhamankar, and Ekaterina Shumilova and U.S. provisional application Ser. No. 61/351,390 filed 4 Jun. 2010 in the names of Alexander A. Messinger, Diana R. Cundell and Brian R. George, with the priority of both of these applications being claimed under 35 USC 119 and 120.

This patent application is a 35 USC 120 continuation-in-part of pending United States utility patent application Ser. No. 12/705,843 filed 15 Feb. 2010 in the names of the aforementioned Alexander A. Messinger, Diana R. Cundell and Brian R. George, with the application being entitled “Methods and Apparatus for Combating Sick Building Syndrome.”

### BACKGROUND OF INVENTION

1. Field of the Invention

This invention relates to fabrics, yarns and filaments having anti-microbial, microbicidal properties that induce morbidity in microorganisms, and to methods for making such fabrics, yarns and filaments, preferably using naturally occurring anti-microbial, microbicidal substances.

2. Description of the Sick Building Syndrome Problem and the Prior Art

Current design of buildings seeks to maximize energy efficiency and comfort for the building inhabitants using centralized heating and cooling systems. As a result, new buildings are becoming increasingly airtight, relative to buildings of prior years. Combined with the use of inexpensive building materials such as particle board, drywall and acoustical tile, the modern design and construction approach has fostered a series of ailments affecting people living and working in these buildings. These ailments are collectively termed Sick Building Syndrome (SBS).

“Sick” buildings are characterized by poor air circulation and imbalance in humidity, which together allow build-up of biological and chemical contaminants.

The adverse impact, both economically and on public health, is significant. The United States Environmental Protection Agency estimates that $61 billion dollars are lost in medical costs and worker absenteeism annually.

If ventilation and lighting could be improved in commercial buildings in the United States, estimates are that there would be somewhere between 16 million and 37 million fewer cases of influenza and the common cold each year, and an 8% to 25% decrease in symptoms for the 53 million persons suffering from allergies and the 16 million asthmatic persons, and further that there would be a 20% to 50% reduction in so-called “Sick Building Syndrome Health Symptoms”.

Reportedly, SBS health symptoms are most prevalent in persons suffering from allergies and asthma; their sensitivity is often high to even low levels of indoor airborne biological contaminants including microbes, especially molds. Since allergies to affect about 1 person in every 6 in the United States, build-up of these indoor contaminants is clearly of great concern.

While studies show that locations with SBS may have high levels of both airborne molds and bacteria, most researchers have devoted their efforts to study of molds and their effects, due to the ease of identification of molds, the dramatic levels of spore release, and responsiveness of molds to remediation by increasing air flow and decreasing humidity.

The consensus among environmental microbiologists is that elevated levels of at least 3 genera of airborne molds, namely penicillium, aspergillus and alternaria, can produce symptoms of SBS. These species, together with cladosporium, are believed to constitute more than 90% of the viable mold flora in ambient air in many environments, with up to a 50% increase in airborne alternaria and cladosporium occurring in Fall and Winter.

Elevated levels of airborne staphylococci, as well as aerosolized water contaminated by legionella or gram-negative bacteria and their products, have also been linked with SBS. Collectively, these bacteria are the dominant species in ambient air and are important agents for a wide range of infectious respiratory, gastro-intestinal, and cutaneous human diseases.

Current literature addressing microbes involved in SBS identifies several mold species, but bacteria in closed rooms are not well addressed. Antibacterial fabrics currently available are primarily those coated with or coupled to compounds that are not environmentally friendly, such as metals and especially silver and tin.

Products currently promoted to remove such airborne contaminants primarily focus on allergens and trap them in electrostatically-charged filters, which require periodic replacement or cleaning.

Silver has proven useful acting as a molecular poison against a broad spectrum of molds and bacteria. Chitin, sometimes called “chitosan”, is also used as an antibacterial. It is easy to obtain and more environmentally friendly than heavy metals such as silver. Triclosan is another commonly used substance, and is the active ingredient in antibacterial hand washes, toothpastes and the like.

These materials all have disadvantages, one of the greatest of which is cost. Especially in the case of silver, the current cost is about $6.00 per ounce, and is predicted to rise to as high as $25.00 per ounce or greater within the next several years. Also, toxicity is a problem. Triclosan may break down in water to produce chloroform and dioxins.

Clove oil is a known antibacterial effective against staphylococcus aureus, pseudomonas aeruginosa, clostridium perfringens and Escherichia coli and is an antifungal effective against candida, aspergillus, penicillium and trychophyton.

Clove oil is currently used in mouth care products for toothaches and as a breath freshener, as a filling or cement material as zinc oxide eugenol for tooth repair, as rose oil in perfumery and soaps, as an antioxidant for plastic and rubber, and as an insecticide and for sanitation purposes.

### SUMMARY OF THE INVENTION

In one of its aspects, this invention provides a method for treating fabric to impart antimicrobial, biocidal properties thereto, comprising preparing an aqueous solution preferably of a naturally occurring substance having antimicrobial, biocidal properties, applying the aqueous solution to the fabric preferably to achieve a desired percent by weight of solution in the fabric, preferably drying the fabric and thereafter preferably curing the fabric. The naturally occurring substance is preferably selected from the group consisting of echinacea, calendula, aloe vera, turmeric, chamomile, cloves and eugenol. The fabric preferably includes at least one of cotton and rayon, and the aqueous solution is preferably applied to the fabric by padding the fabric with the solution.

In another one of its aspects, this invention provides a method for imparting antimicrobial, biocidal properties to fabric preferably including cotton, rayon or both, where the method includes the steps of preparing an aqueous solution of preferably between about 5 and about 15 grams of eugenol per liter of solution; preferably between about 5 and about 10 grams of polyvinyl alcohol per liter of solution; and preferably about 100 grams per liter of glyoxal per liter of solution. The method proceeds by applying the aqueous solution to the fabric preferably to achieve about 65% by weight solution in the fabric, drying the fabric preferably at a temperature of between about 80° C. and about 85° C. preferably for about 4 minutes and thereafter curing the fabric preferably at a temperature between about 120° C. and about 140° C. preferably for between about 3 and about 5 minutes. The solution is desirably applied to the fabric by padding the fabric with the solution.

In yet another one of its aspects, this invention provides an antimicrobial, biocidal fabric including a biocidally effective amount of at least one substance selected from the group consisting of echinacea, calendula, aloe vera, turmeric, chamomile, cloves and eugenol. The fabric preferably includes at least one of cotton and rayon.

In yet another one of its aspects, this invention provides a method for combating sick building syndrome by providing a plenum that is at least partially bounded by antimicrobial, biocidal fabric preferably including a biocidally effective amount of at least one substance selected from the group consisting of echinacea, calendula, aloe vera, turmeric, chamomile, cloves and eugenol, and thereafter introducing air preferably from an area manifesting sick building syndrome into the plenum for passage outwardly through the fabric preferably into an area manifesting sick building syndrome.

In still another one of its aspects, this invention provides a method for combating sick building syndrome including the steps of providing an antimicrobial, biocidal fabric having a biocidally effective amount of at least one substance preferably selected from the group consisting of echinacea, calendula, aloe vera, turmeric, chamomile, cloves and eugenol, with the fabric preferably being affixed across a frame. The method then preferably proceeds by blowing air preferably taken from an area manifesting sick building syndrome through a portion of the fabric affixed across the frame and preferably into an area manifesting sick building syndrome.

In yet still another one of its aspects, this invention provides a modular unit for improving indoor air quality where the unit includes a frame surrounding an open interior and preferably defining the outer periphery of the unit, air permeable, antimicrobial fabric preferably comprising a biocidally effective amount of a substance preferably selected from the group consisting of echinacea, calendula, aloe vera, turmeric, chamomile, cloves and eugenol, preferably secured about the frame periphery on a first side of the frame and covering the open interior on a first side of the frame, and air impermeable members secured about and preferably covering the frame periphery on a remaining side of the frame, with at least one aperture being formed in the frame and adapted to house a fan therein, with the fan being housed in the aperture for blowing air from outside the frame into the frame interior for subsequent passage of air blowing into the frame interior outwardly through the fabric.

In still yet another one of its aspects, this invention provides apparatus for combating sick building syndrome where the apparatus includes a plenum at least partially bounded by fabric comprising a biocidally effective amount of a substance preferably selected from the group consisting of echinacea, calendula, aloe vera, turmeric, chamomile, cloves and eugenol, and a fan for introducing air into the plenum for passage outwardly through the fabric.

In still yet another one of its aspects, this invention provides apparatus for combating sick building syndrome where the apparatus includes fabric preferably comprising a biocidally effective amount of the substance selected from the group consisting of echinacea, calendula, aloe vera, turmeric, chamomile, cloves and eugenol, a frame adapted for affixation of the fabric thereacross, and a fan for blowing air through a portion of the fabric affixed across the frame.

In yet still another one of its aspects, this invention provides a modular unit for improving indoor air quality where the unit includes a frame surrounding an open interior and preferably defining the outer periphery of the unit with air permeable fabric including cotton, rayon or both, treated to be antimicrobial and biocidal. The fabric is preferably treated to be biocidal by preparing an aqueous solution consisting of preferably between about 5 and about 15 grams of eugenol per liter of solution, preferably between about 5 and about 10 grams of polyvinyl alcohol per liter of solution, and preferably about 100 grams per liter of glyoxal per liter of solution, applying the aqueous solution to the fabric to preferably achieve about 65% by weight solution pick up, drying the fabric preferably at between about 80° C. and about 85° C. preferably for about 4 minutes, and curing the fabric at between about 120° C. and about 140° C. preferably for between about 3 and about 5 minutes. The apparatus preferably further includes an air impermeable member secured about and covering the frame periphery on a remaining side of the frame, at least one aperture formed in the frame and adapted to house a fan therein, and a fan housed in the aperture for blowing air from outside the frame into the frame interior for subsequent passage of air blown into the frame interior outwardly through the fabric.

In still another one of its aspects, the invention includes apparatus for combating sick building syndrome where the apparatus preferably includes a plenum at least partially bounded by fabric including cotton, rayon or both, which has been treated to antimicrobial and biocidal. The fabric is preferably treated by preparing an aqueous solution preferably consisting of between about 5 and about 15 grams of eugenol per liter of solution, between about 5 and about 10 grams of polyvinyl alcohol per liter of solution, and about 100 grams per liter of glyoxal per liter of solution. The aqueous solution is preferably applied to the fabric preferably to achieve at least about 65% by weight of solution pick-up. The fabric is preferably dried at between about 80° C. and about 85° C. for about 4 minutes and is preferably is cured at between about 120° C. and about 140° C. for between about 3 and about 5 minutes. The apparatus preferably further includes a fan for introducing air into the plenum for passage outwardly through the fabric.

In still yet another one of its many aspects, this invention provides apparatus for combating sick building syndrome where the apparatus has fabric that includes cotton or rayon or both, which fabric is treated to be antimicrobial and biocidal. The fabric is preferably treated by preparing an aqueous solution consisting of about 5 and about 15 grams of eugenol per liter of solution, between about 5 and about 10 grams of polyvinyl alcohol per liter of solution, and about 100 grams per liter of glyoxal per liter of solution. The solution is applied to the fabric to achieve preferably at least about 65% by weight of solution pick up. The fabric is then dried at between about 80° C. and about 85° C. for about 4 minutes. The fabric is then cured at between about 120° C. and about 140° C. for between about 3 and about 5 minutes. The apparatus preferably further includes a frame adapted for affixation of the fabric thereacross and a fan for blowing air through a portion of the fabric affixed across the frame.

In yet still another one of its aspects, the invention provides a method for combating sick building syndrome comprising blowing air through an antimicrobial fabric including a biocidally effective amount of a substance selected from the group consisting of echinacea, calendula, aloe vera, turmeric, chamomile, cloves and eugenol.

In still yet another one of its aspects, the invention provides a method for combating sick building syndrome by position for convective air flow thereagainst and antimicrobial fabric including a biocidally effective amount of a substance selected from the group consisting of echinacea, calendula, aloe vera, turmeric, chamomile, cloves and eugenol.

### BRIEF DESCRIPTION OF THE DRAWINGS

Drawing A is an exploded isometric drawing of one style of a modular unit for improving indoor air quality and combating SBS, with which fabrics according to the invention are suitably used.

Drawing B is an exploded isometric drawing of a second style of modular unit for improving indoor air quality and combating SBS, with which fabrics according to the invention are suitably used, with the unit including a breathing light shelf.

Drawing C is an exploded isometric drawing of a third style of a modular unit for improving indoor air quality and combating SBS, with which fabrics according to the invention are suitably used.

Drawing D is an isometric drawing of apparatus for preferably passively improving indoor air quality in the form of an upstanding modular vertically suspended fabric array.

Drawing E is an isometric drawing of additional apparatus for preferably passively improving indoor air quality in the form of an upstanding modular vertically suspended fabric array, similar to that illustrated in Drawing D, in accordance with aspects of the invention.

Drawing F is an isometric drawing of still additional apparatus for preferably passively improving indoor air quality in the form of an upstanding modular vertically suspended fabric array, similar to that illustrated in Drawings D and E.

Drawing G is a broken isometric drawing of one of the five vertically extending segments of the apparatus for preferably passively improving indoor air quality illustrated in Drawing D.

Drawing H is a broken isometric drawing of one of the five vertically extending segments of the apparatus for preferably passively improving indoor air quality illustrated in Drawing F.

In the drawings, prime and hyphenation notations are used to identify functionally equivalent component incorporated into different embodiments or aspects of the invention, e.g., 14, 14′, 14-1, etc.

### DESCRIPTION OF THE PREFERRED EMBODIMENTS AND BEST MODE KNOWN FOR PRACTICE OF THE INVENTION

Knit, woven and non-woven fabrics of different fiber types, such as cotton, rayon, polyester, nylon and wool, can be used in the practice of the invention; these fibers themselves are not antimicrobial. Natural antimicrobials found to be biocidally effective are attached to these fabrics in accordance with the invention.

Typically, a fabric according to the invention may be fabricated using antimicrobial morbidity-inducing synthetic, natural or blended yarns knitted or woven into fabric, for example, a 1×1 ribbed fabric and/or into a 1×1 plain fabric. A desirable heavier construction of ribbed fabric eliminates tearing issues sometimes encountered using plain fabric.

One method for imparting microorganism morbidity-inducing biocidal properties into a fiber in accordance with the invention is to incorporate clove powder, known to be a natural antimicrobial, into polymeric, preferably polypropylene, filaments by extrusion. This may be accomplished by mixing clove powder with polypropylene pellets prior to the mixture being fed through an extruder. The extruder provides as output a filament consisting of the extruded mixture of polypropylene and clove powder. Proper mixing of the clove powder and the pellets prior to the extrusion process is important; if the mix is not uniform, there will not be a consistent blend of clove powder and polypropylene along the length of the extruded filaments. Once the filaments are extruded, those filaments may be woven or knit into fabrics.

Additional aspects of the invention involve combining preferably naturally occurring botanically based antimicrobials with cotton, rayon and other fabrics, by treating the fabric with the botanically based antimicrobial to provide a fabric having biocidal properties. The fabric may be a knit having the ability to be tightly stretched across an SBS unit frame. This aspect of the invention may also be practiced with woven fabrics. Preferable naturally occurring antimicrobials may be applied to other forms of fabric as well, such as braided and non-woven fabrics, and to yarns, fibers and filaments from which these fabrics are made, using the methods of the invention.

The invention further embraces treating fabric to impregnate the fabric with preferably naturally occurring antimicrobials, which is preferable to treating yarns or fibers or filaments except for when extrusion is the method of application of the naturally occurring antimicrobial. When using extrusion, yarn or fiber or filament must be extruded together with the selected natural antimicrobial and then woven or knit into fabric to provide the desired result.

The methods of the invention may be used to impregnate yarns or fibers with naturally occurring antimicrobials, since yarn or fiber does not change its structure during fabric production by knitting or weaving.

The methods of the invention may be used to produce antimicrobial fabrics where the fabrics are initially knitted using yarns containing recycled fibers. The fiber content of these yarns may be in the range of about 69% cotton, about 29% acrylic and about 2% other fiber. Such recycled fibers are preferably previously dyed and preferably undergo processing treatments as well as shedding during the recycling. Dyeing does not affect the efficacy of the fabric treatment that produces the antimicrobial, morbidity-inducing property in the fabric.

A major advantage provided by fabrics treated in accordance with the invention is that these fabrics not only trap microbes but also kill them. This is important since a filter, such as for an air conditioner, a vacuum cleaner and the like, which is not cleaned regularly, can act as an entrapment point for microbes that continue to breed after being trapped there, especially if moisture is present. This is especially important in the case of Bacillus spores of bacteria, which live up to two hundred (200) years.

Some commercially available fabrics are active against some bacteria and are promoted as being “antibacterial”, but antimicrobial, biocidal fabrics in accordance with the invention are also active against mycetes, namely molds, which constitute the dominant airborne microbes in closed rooms. Fabrics in accordance with the invention are more effective relative to commercially available allegedly “antibacterial” fabrics, as fabrics in accordance with the invention can be kept in place for at least one month while retaining reactivity and also can be washed at least once without losing their capacity for inducing morbidity in microorganisms.

Since fabrics in accordance with the invention are preferably made by treatment with natural biocides, a consumer can wash the fabrics in accordance with the invention in a home washing machine. Tests have shown that there is no significant reduction in the antimicrobial, biocidal properties of fabrics treated in accordance with the methods of the invention after those fabrics have been laundered. More particularly, tests have shown no bacterial or fungal growth directly on the surface of the laundered fabric and a complete inhibition of the challenge microorganism when compared to a control. In these tests of the laundered fabric, which had been treated in accordance with the invention, the microorganisms used were: staphylococcus aureus ATCC 6538, pseudomonas aeruginosa ATCC 9027, bacillus subtilis ATCC 6633, mycobacteria smegmantis ATCC 14468, staphylococcus aureus MRSA strain ATCC 33592, and aspergillus niger ATCC 16404. Also, since fabrics in accordance with the invention are made by treatment with naturally occurring biocides, fabrics may be discarded without producing a health hazard. Fabrics in accordance with the invention are preferably biodegradable.

Among the naturally occurring antimicrobial, morbidity-inducing materials that may be used in the course of practice of the invention in treating fabric are echinacea, calendula, aloe vera, turmeric, chamomile, cloves and eugenol, with the latter preferably coming from the clove plant. Cloves and eugenol from cloves are the most preferable, and may preferably be used with natural fabrics such as cotton and silk; with semi-artificial fabrics such as cotton-polyester and cotton-rayon; and with artificial fabrics such as viscose and rayon. The methods of the invention couple these naturally occurring microbicidal materials to the fabrics; the resulting fabrics retain their new microbicidal properties, even following substantial air exposure and washing.

In vitro studies comparing the fabrics of the invention with commercial “antibacterial” fabric demonstrate that fabrics according to the invention are at least as good, if not substantially better, at killing bacteria as commercially available “antibacterial” fabric and, in addition, fabrics according to the invention kills the molds.

Certain evaluations of the fabric treatment processes in accordance with the invention utilized clinical pathogens commercial strains of the five most common nosocomial agents, namely Pseudomonas aeruginosa, methicillin-resistant Staphylococcus aureus (MRSA), Escherichia coli, Clostridium difficile and vancomycin-resistant enterococci (VRE), as well as strains of Mycobacterium smegmatis (models tuberculosis bacillus sensitivities), Streptococcus pneumoniae and S. agalacticae.

In one of its aspects, the invention embraces six naturally occurring biocides, which were tested for activity using both the extract and following coupling to three natural, renewable woven fabrics namely cotton, rayon and a cotton-polyester blend. These were chosen since cellulosic materials offer several reactive groups to which the antimicrobial agents could be bonded. Assessment of antimicrobial activity in the inventive fabrics was compared with a commercially available putative antimicrobial fabric first by a modification of the standard American Association of Textile Chemists and Colorists (AATCC) qualitative method 147-1998 termed a “halo” assay. This involved applying a pure culture of test microbe to cover the surface of a clear nutrient agar plate and overlaying this with small pieces of inventive antimicrobial fabric. After a 24 hour incubation period at 37° C., a clear zone of “no growth” was then indicative of antimicrobial activity.

Fabrics in accordance with the invention that were positive for this test were then further analyzed quantitatively for their ability to reduce microbial growth over a 48 hour period using the ASTM E2149-01 method. This latter method was chosen over the standardized AATCC 100 method as it was suitable for both bacteria and molds using the same methodology and ensured the optimal contact of the fabric with the suspended microbes. This method involved the addition of 0.5 g of fabric cut into strips to a microbial suspension of approximately 1×10⁵ colony forming units (CFU) per ml. After overnight incubation at 37° C., in a shaking bath, the number of viable (living) microbes remaining was determined by performing serial dilutions, further incubating at 37° C. and enumerating visually. Reduction in the numbers of bacteria fungi were then calculated by the following equation, where R=percentage reduction of bacteria fungi by the specimen treatments, B=number of bacteria fungi (CFU/ml) recovered from the microbial suspension at the beginning of the experiment and A=number of bacteria fungi (CFU/ml) recovered from the microbial suspension at the end of the experiment after the 24 hour incubation period (CFU/ml):

R=100(B−A)/B

Each evaluation was repeated on three separate occasions and the incubations performed in duplicate. This allowed for the identification of both microbicidal (killing) fabrics and microbistatic (prevention of multiplication) fabrics; microbicidal fabrics were those where the percentage of viable microbes was reduced by ≧4 log units, i.e. growth was decreased up to 10,000-fold or less than 1% of that expected, whereas microbistatic was any decrease in growth of 2 log units or less. The invention focuses on coupled fabrics that are microbicidal only and demonstrates that natural biocides are effective when coupled to cotton and viscose-rayon.

A bioactive fabric in accordance with the invention have been tested in a small room in Philadelphia, Pa. with poor air quality and natural light access over a one month period. Construction and installation of apparatus as shown in Drawing A was followed by immediate sampling of the air using standard environmental microbiological techniques, namely air sampling using BioStage® Bioaerosol Impactor sampler using tryptic soy agar with and without sheep blood (5%) and nutrient agar for mycetes and the use of sedimentation plates.

Various sites in the room were assessed for air quality. Over a 21 day period the levels of both bacteria and fungi fell in the ambient air. The bacteria were somewhat slower in their decline compared with the mycetes. One assessed location was the major source of any air into the room and those bacteria primarily recovered were Bacilli, which are spore-producers. Given the bactericidal and sporicidal abilities of the fabric against Bacilli, it seems likely that these were less likely to represent vegetative bacteria but spores throughout the assessment period with the fabric eventually removing them to acceptable levels. The molds recovered from this location belonged to two species, namely Aspergillus and Penicillium; both of which were effectively removed from the ambient air.

### Extrusion Example 1

Eugenol, in the form of crushed cloves, was mixed with Pro-Fax MI40 polypropylene pellets obtained from Himont, Inc. The pellets had a diameter of approximately 3 mm. Mixing was done manually using a stirring rod and beaker. The mixture was then extruded using an Atlas Laboratory mixing extruder at a temperature of about 200° C. The filaments were air cooled, collected, and found to exhibit antimicrobial morbidity-inducing properties.

### Extrusion Example 2

A blend of 5% by weight corn gluten meal and 95% polypropylene chips was extruded into a continuous filament using an Atlas Laboratory mixing extruder. The filament as air cooled, collected, and found to exhibit antimicrobial morbitity-inducing properties.

### Fabric Treatment Example 1

An aqueous solution consisting of 5 grams of Sigma Aldrich-supplied eugenol per liter of water, grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 3 minutes. An anti-microbial fabric resulted.

### Fabric Treatment Example 2

An aqueous solution consisting of 50 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 3 minutes. An anti-microbial fabric resulted.

### Fabric Treatment Example 3

An aqueous solution consisting of 15 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 3 minutes. An anti-microbial fabric resulted.

### Fabric Treatment Example 4

An aqueous solution consisting of 5 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 5 minutes. An anti-microbial fabric resulted.

### Fabric Treatment Example 5

An aqueous solution consisting of 10 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 5 minutes. An anti-microbial fabric resulted.

### Fabric Treatment Example 6

An aqueous solution consisting of 15 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 5 minutes. An anti-microbial fabric resulted.

### Fabric Treatment Example 7

An aqueous solution consisting of 5 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 3 minutes. An anti-microbial fabric resulted.

### Fabric Treatment Example 8

An aqueous solution consisting of 10 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 3 minutes. An anti-microbial fabric resulted.

### Fabric Treatment Example 9

An aqueous solution consisting of 15 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 3 minutes. An anti-microbial fabric resulted.

### Fabric Treatment Example 10

An aqueous solution consisting of 5 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 5 minutes. An anti-microbial fabric resulted.

### Fabric Treatment Example 11

An aqueous solution consisting of 10 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 5 minutes. An anti-microbial fabric resulted.

### Fabric Treatment Example 12

An aqueous solution consisting of 15 grams of Sigma Aldrich-supplied eugenol per liter of water, 5 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 5 minutes. An anti-microbial fabric resulted.

### Fabric Treatment Example 13

An aqueous solution consisting of 5 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 3 minutes. An anti-microbial fabric resulted.

### Fabric Treatment Example 14

An aqueous solution consisting of 10 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 3 minutes. An anti-microbial fabric resulted.

### Fabric Treatment Example 15

An aqueous solution consisting of 15 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 3 minutes. An anti-microbial fabric resulted.

### Fabric Treatment Example 16

An aqueous solution consisting of 5 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 5 minutes. An anti-microbial fabric resulted.

### Fabric Treatment Example 17

An aqueous solution consisting of 10 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 5 minutes. An anti-microbial fabric resulted.

### Fabric Treatment Example 18

An aqueous solution consisting of 15 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 120° C. for 5 minutes. An anti-microbial fabric resulted.

### Fabric Treatment Example 19

An aqueous solution consisting of 5 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 3 minutes. An anti-microbial fabric resulted.

### Fabric Treatment Example 20

An aqueous solution consisting of 10 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 3 minutes. An anti-microbial fabric resulted.

### Fabric Treatment Example 21

An aqueous solution consisting of 15 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 3 minutes. An anti-microbial fabric resulted.

### Fabric Treatment Example 22

An aqueous solution consisting of 5 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 5 minutes. An anti-microbial fabric resulted.

### Fabric Treatment Example 23

An aqueous solution consisting of 10 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 5 minutes. An anti-microbial fabric resulted.

### Fabric Treatment Example 24

An aqueous solution consisting of 15 grams of Sigma Aldrich-supplied eugenol per liter of water, 10 grams of Sigma Aldrich-supplied 80% hydrolyzed polyvinyl alcohol per liter of water, and 100 grams of Alpha Aesar-supplied glyoxal (40% weight/weight aqueous solution) per liter of water, was prepared by mixing the eugenol, polyvinyl alcohol and the glyoxal with tap water on their weight bases. The solution was prepared in an amount so that the weight ratio of fabric (which was to be treated) to solution was 1:10.

Using a 50 centimeter wide 2 roll Werner Mathis AG padder, 100% cotton fabric was padded with the solution at a rate of 65% wet pickup of the solution by the fabric. Using a Tsujii Senki Kogyo Co. Ltd. through-air oven, having a 205 centimeter long heating zone, the fabric was dried at 80° C. for 4 minutes. The dried fabric was then cured at 140° C. for 5 minutes. An anti-microbial fabric resulted.

Tests have demonstrated successful processing to produce novel, naturally biocidal, biodegradable and environmentally-friendly fabric able to trap and to kill airborne mold and bacteria contaminates and their spores, at a level at or exceeding 90%. The biocidal antibacterials have been successfully processed to couple to fabric in a way to have no effect on the strength or drape of the fabric, with the fabric having demonstrated retention of the microbicidal activity for at least from four to six weeks without needing laundering. Thereafter, the fabric has been washed using a cold wash and rinse cycle without loss of biocidal, antimicrobial activity.

While the invention discloses and claims use of antimicrobial biocidals with natural fibers without alteration of their functionality, the inventors are of the belief that synthetic fibers may also be utilized, thus increasing the range of industrial purposes into which the materials may be incorporated.

The ability of the fabric to effectively kill at least six strains of gram positive bacteria, one of which is spore-producing, and four environmentally-important molds, both during in-vitro and, for the molds and two of the bacteria strains, in situ, strongly indicates that fabrics according to the invention are important in the control of both clinical and environmental pathogens.

The antimicrobial biocidal properties of the fabrics treated in accordance with the foregoing twenty-four fabric treatment examples were assessed using industry standards as established by the American Association of Textile Chemists and Colorists (AATCC) and by the American Society for Testing Materials (ASTM), with the fabrics being evaluated using two methodologies namely AATCC 147-1998 and AATCC 100/ASTM E2149-01, which respectively provide qualitative and quantitative assessment of antimicrobial activity. A positive qualitative finding (AATCC 147-1998) required a minimum zone of clearance around the test fabrics of ≧3 mm, with the quantitative test demonstrating microbicidal efficacy with a reduction in microbial growth of by ≧4 log units, i.e. growth was decreased up to 10,000-fold or less than 1% of that expected under ASTM E2149-01. Testing of the fabrics was in accordance with and addressed these industry standards. Using these assessment tools the fabrics treated in accordance with the foregoing examples were determined to be natural, bioactive, environmentally friendly, and biodegradable, and able to both trap and kill both gram positive bacteria and molds effectively and rapidly. As such the treated fabrics are effective against microbes in their natural habitat and are able to eliminate both environmental microbes isolated from rooms with poor airflow and commercially-available clinical strains.

While the foregoing Fabric Treatment Examples have all been detailed as using 100% cotton fabric, the fabric treatments as set forth in the Fabric Treatment Examples above have been proven effective also for fabrics that are 50% cotton and 50% polyester; for fabrics that are 100% rayon; and for fabrics that are 68% cotton, 30% acrylic and 2% other. Moreover, it has been within the scope of the invention to use the treatment examples and processes as detailed above for any fabrics containing cotton or rayon, whether in pure or blended forms.

Additionally, the examples as set forth above were repeated but using just eugenol in the 5 gram per liter, 10 gram per liter and 15 gram per liter strengths, without the addition of the other auxiliaries. The solutions were made by mixing the additives with tap water on their weight bases. Padding was performed as described above, and drying was performed as described above. These variations in treatment were also successful in creating antimicrobial fabrics.

The invention further embraces additional methods of affixing natural herbal antimicrobial, biocidals to fabrics containing 100% cotton, or 100% viscous rayon, or a 50/50% blend of cotton and polyester.

The natural antimicrobial biocidals used include crushed cloves mixed with water at a rate of 2% by weight to create an aqueous solution; turmeric powder similarly mixed with water to create a 2% by weight aqueous solution; citric acid similarly mixed with water to create a 5% by weight aqueous solution; and corn gluten meal, similarly mixed with water to produce a 5% aqueous solution. The fabrics, namely 100% cotton fabric; 100% viscous rayon fabric; and a 50/50% cotton/polyester fabric were immersed in the aqueous solutions for 30 minutes at room temperature and stirred at a constant rate. The fabrics were then rinsed in cold water and allowed to line dry. Once dry, the fabrics were evaluated for their antimicrobial, biocidal activity. Fabric samples processed using this method were 10 cm.×10 cm.; solutions were prepared in beakers; the stifling was performed by hand.

The invention further embraces treatment of 100% cotton and 100% viscous rayon fabric with other natural, herbal antimicrobial biocidals. These biocidals include German chamomile, Echinacea supreme, calendula oil, aloe vera and clove oil. The fabrics were treated by mixing the selected biocidal, namely German chamomile, Echinacea supreme, calendula oil, aloe vera or clove oil with water and solutions containing 5% by weight of the biocidal. The resulting solution was applied to the fabric by immersing the fabric solution in a beaker, hand mixing the solution with the fabric immersed in the solution, rinsing the fabric and drying the fabric. In each case, biocidal properties in the treated fabric resulted.

In further aspects of the invention, clove oil was mixed with sodium bicarbonate and applied to 100% cotton fabrics, 100% viscous rayon fabrics, and to 50/50% cotton/polyester fabrics. The mixing and drying were as described immediately above. Similarly, clove oil was mixed with acetyl chloride and applied to 100% cotton fabrics, 100% viscous rayon fabrics and to 50/50% cotton/polyester fabrics, with the mixing and drying protocol as set forth immediately above. Also, eugenol was mixed with acetyl chloride and applied to 100% cotton fabrics, 100% viscous rayon fabrics, and 50/50% cotton/polyester fabrics with mixing and drying according to that set forth immediately above. In each of these cases, 5% of the solution was the nature ingredient. Antimicrobial, biocidal properties resulted in the treated fabrics.

In Drawing A, the unit for treating and alleviating SBS thereby improving indoor air quality is shown to be a modular unit designated generally 10 that includes a frame designated generally 12 surrounding an open interior and defining an outer periphery of unit 10. As shown in Drawing A, one or two layers 14 and 14′ of air permeable, antimicrobial, morbidity-inducing fabric, comprising at least one of naturally occurring antimicrobial botanicals disclosed herein, are secured about the periphery of frame 12 on a first side 30 of frame 12, with fabric 14 facingly contacting the open interior of frame 12 on first side 30 of frame 12, and with fabric 14′ facingly contacting fabric 14 and lying congruently thereover. In this example, as noted above, a single layer of fabric 14 was used.

At least one aperture 18 is formed in frame 12. Aperture 18 houses a fan 20 therein, is depicted schematically in Drawing A. A second aperture 18′ may also be provided as illustrated to house a second optional fan 20′ or may be used for air bleed.

Fan 20, being housed in aperture 18, serves to blow air from outside of frame 12 into the interior of frame 12 for subsequent passage of substantially all air that is blown into the frame interior, outwardly through fabric 14.

The arrows identified in Drawing A by letters “Ar” indicate the manner of assembly of unit 10, which is shown in Drawing A in a partially exploded isometric view.

The remaining or second side 32 of frame 12 may be open as illustrated, or may be covered with one or more layers of air permeable, antimicrobial, morbidity-inducing fabric.

Still referring to Drawing A, frame 12 has four members, two of which are first and second upstanding lateral members 34 and 36, which are spaced apart as illustrated in Drawing A; the remaining two members of frame 12 are top member 38 and bottom member 40.

Frame 12 further preferably includes first and second diagonal bracing cables 44 and 46, each of which extend from a lower interior corner of frame 12, defined by juncture of bottom 40 and upstanding side member 34 or 36, to a diagonally opposite upper corner, defined by juncture of top 38 with either upstanding side member 36 or upstanding side member 34. Diagonal bracing cables 44 and 46 are secured in place, desirably by connecting with eyes driven into the wood or particle board construction, at a location close to, if not exactly at, the line of juncture between the top and bottom members 22, 24 and the respective side members 34, 36. The eyes and the particular securement of diagonal bracing cables 44 and 46 to frame 12 have not been illustrated to enhance drawing clarity.

The remaining or second side 32 of frame 12 in the unit illustrated in Drawing A has been illustrated open, not covered with fabric. Unit 10 is equipped with a hanging cable 48 connected to second side 32 of frame 12 by suitable screw and collar assemblies, which have not been detailed or numbered in Drawing A to enhance drawing clarity. As shown in Drawing A, screws are driven into the second side 32 of frame 12 at the four corners of second side 32 and collars are then secured in place by screws and permit a small degree of movement of hanging cable 48. Presence of hanging cable 48 facilitates hanging unit 10 on and against a wall, with the wall thereby effectively closing second side 32 of frame 12 if that side is not covered by one or more layers of fabric.

Hanging cable 48 and the unnumbered screws and collars that connect hanging cable 48 to the remainder of the structure may also optionally be positioned to maintain frame 12 slightly away from the wall on which unit 10 is mounted. This is desirable when the remaining or second side 32 of frame 12 is covered with one or more layers of air permeable, antimicrobial, morbidity-inducing fabric, prepared in accordance with the invention. Unit 10, using hanging cable 48, can be mounted against any reasonably imperforate wall surface; provision of hanging cable 48 permits unit 10 to be mounted essentially flush against the surface of the wall on which unit 10 is mounted. Molly bolts, hooks or the like, driven into a wall may be used to hang unit 10 on the wall.

While unit 10 has been illustrated with two thicknesses of air permeable, antimicrobial, morbidity-inducing fabric 14 and 14′, a single fabric thickness may be used, depending on the amount of air moved by fan 20 as selected in specifying fan 20. Additionally, while one or more layers of air permeable, antimicrobial, morbidity-inducing fabric, comprising at least one naturally occurring antimicrobial botanical, may be used on the front and rear surfaces of frame 12, an aesthetically pleasing, air permeable fabric lacking antimicrobial and morbidity-inducing properties may be used as the outermost fabric 14′ to enhance the aesthetics of unit 10.

Frame 12 of unit 10 is preferably assembled from particle board or wood using adhesive, screws or other mechanical means to secure the parts of frame 12 together in the manner indicated by arrows Ar in Drawing A. The screws, adhesive or other mechanical means used in the assembly of frame 12 have not been illustrated in Drawing A to enhance clarity of the drawing. Frame 12 is preferably of generally rectangular configuration with frame 12 preferably being higher than it is wide.

The air permeable, antimicrobial, morbidity-inducing fabric 14 in accordance with the invention is preferably secured about the edges of frame 12 that face fabric 14 when fabric 14 and frame 12 are oriented in the position illustrated in Drawing A. Velcro is preferably used to secure fabric 14 to the surfaces of frame 12 that face fabric 14 when those parts are oriented as illustrated in Drawing A. Similarly, Velcro is preferably used to secure fabric 14′ to the surface of fabric 14 when those fabric layers are oriented as illustrated in Drawing A. The Velcro has not been illustrated in order to enhance the drawing. Use of Velcro facilitates replacement of the fabric on a periodic basis.

When unit 10 is assembled by putting the parts of frame 12 in place as indicated by arrows Ar, by positioning fan 20 within aperture 18, and by attaching fabric 14 and 14′ to the facing edges of frame 12 using the preferable Velcro, and unit 10 is either mounted flushly against a wall or has fabric 14′ covering the rear or second side of unit 10, the interior of frame 12 is open other than for the presence of diagonal bracing cables 44, 46. The open construction provides a plenum that is at least partially bounded by fabric 14. When fan 20 operates, fan 20 introduces air into the plenum defined by the interior of unit 10 and forces air gently outwardly through fabric 14 and fabric 14′. Fabrics 14 and 14′ are both air permeable and preferably each has antimicrobial, morbidity-inducing characteristics due to having been treated with the naturally occurring botanical, antimicrobial, morbidity-inducing material, preferably clove powder or eugenol in accordance with the invention. Hence, when room air is forced gently into the open interior of unit 10, defining a plenum, and then outwardly through fabric 14, 14′, airborne bacteria and other contaminants are trapped and killed by fabric 14 and 14′.

As also apparent from Drawing A, frame 12 has a generally rectangular configuration such that first side 30 and second side 32 are parallel one with another and such that top 38 and bottom 40 are parallel one with another. Additionally, the edges, which are unnumbered in the drawings, of the first and second sides 30, 32 and top and bottom 38, 40, are all coplanar, thereby presenting a flat, rectangular, frame-like surface for preferable adhesive securement of the Velcro male or female portion that mates with the counterpart Velcro portion affixed to fabric 14. Fabric 14 and fabric 14′ are both preferably rectangularly shaped and dimensioned to fit congruently with the facing edges of first and second sides 30, 32 and the facing edges of top and bottom 38, 40 defining the rectangular shape of frame 12 so there is no substantial overlap of fabric 14, 14′ respecting frame 12, and so there is no opening between an edge of fabric 14 and a portion of frame 12 through which air could escape without passing through fabric 14.

Referring generally to Drawing B, the apparatus for treating and alleviating SBS and improving indoor air quality is in the form of a modular unit designated generally 10A that includes a frame designated generally 12A surrounding an open interior and defining an outer periphery of unit 10A. In Drawing B, apparatus 10A is illustrated in a horizontal disposition and, as shown in the left hand portion of Drawing B, is adapted to be used in such a horizontal orientation.

As further illustrated in the left-hand portion of Drawing B, unit 10A is mounted in a horizontal disposition on a unit support frame designated generally 70 positioned within a structure designated generally 60 and in essentially facing contact with the interior surface of a window, or at least the frame of the window, designated generally 58. Unit support frame 70 is maintained in place and vertically supported by cable 68 preferably connected to hooks 66 mounted in the interiorly facing surface of wall 62, above window 58.

Unit support frame 70 preferably includes an inner member designated generally 72 and an outer member designated generally 74 as shown in the left-hand portion of Drawing B. Outer member 74 is dimensioned to vertically support unit 10A by contact with a downwardly facing portion thereof, preferably the downwardly facing portion of frame 12A of unit 10A, as illustrated at the extreme left-hand side of Drawing B. Inner member 72 of unit support frame 70 is dimensioned to receive unit 10A in a facing, complemental manner with unnumbered vertically extending, horizontally facing surfaces of inner member 72 facingly contacting the interiorly positioned one of lateral members 26A and members 22A and 24A. The portion of inner member 72 extending essentially perpendicularly inwardly from window 58 is dimensioned to stop short of the position of fan 20A in aperture 18A, all as illustrated in the extreme left-hand portion of Drawing B.

Optional solar cells 64 may be positioned in facing contact with window 58 to receive sunlight and thereby generate electricity. Solar cells 64 are connected by wires, not shown in the drawings, to fans 20A so that fans 20A are driven by solar energy received through window 58, such that batteries may not be required for fans 20A.

In one preferable implementation illustrated in Drawing B, fabric 14A on the upper side of unit 10A may be a non-woven fabric that is not only air permeable and antimicrobial with morbidity inducing properties in accordance with the invention, but is also reflective in a manner to reflect natural light, coming in through window 58, throughout the room in which unit 10A is mounted. Distribution of natural light within a room having SBS symptoms helps to alleviate those symptoms and in combination with the air purification effectuated by unit 10A provides synergistic results as respecting elimination of SBS.

Referring specifically to Drawing C of the unit for treating and alleviating SBS thereby improving indoor air quality, it is depicted in the form of a modular unit designated generally 10B that includes a frame designated generally 12B surrounding a generally open interior and defining an outer periphery of unit 10B. Referring still to Drawing C, frame 12B and the parts thereof, namely top member 22B, bottom member 24B, lateral members 26B, horizontal interior bracing member 52B, fans 20B and 20B′ and apertures 18B and 18W are preferably substantially identical to the correspondingly numbered components of unit 10 illustrated in Drawing A.

In Drawing C, the air permeable, antimicrobial, morbidity-inducing fabric in accordance with the invention is furnished in the form of modular fabric panels designated generally 54 in Drawing C, where each modular fabric panel includes a frame 56 that is generally of rectangular construction with an open center. Preferably two layers of air permeable, botanically based, antimicrobial, morbidity-inducing fabric 14B and 14B are a part of each modular fabric panel 54 with a first layer of fabric 14B secured to one side of frame 56 and a second layer of fabric 14W secured to a second side of frame 56, where the fabric in both instances is preferably secured to frame 56 using Velcro. In Drawing C, to enhance drawing clarity, the frames 56 of modular fabric panels 54 have been illustrated only for modular fabric panels 54 on the right side of the drawing. Similarly, fabric layer 14B has been designated only for those modular fabric panels on the right side of the drawing and fabric layer 14B′ has been designated only for those modular fabric panels on the left side of the drawing.

Each modular fabric panel preferably includes two layers of fabric, one on either side of fabric panel frame 56. Modular fabric panels 54 may be dimensioned such that when mounted on frame 12B there is some overlap of the upper and lower panels by the middle panel as illustrated in Drawing C; unit 10B may also be constructed such that modular fabric panels 54 all collectively fit flushly one against another on one side of frame 12B to present a smooth, continuous surface of air permeable, antimicrobial, morbidity-inducing fabric, preferably comprising a naturally occurring antimicrobial botanical compound, for passage of treatment air therethrough.

In one exemplary manifestation, the unit for treating SBS as illustrated in Drawing C can be about 19 inches wide and about 44 inches high. As illustrated, three panels of fabric may be positioned on each side of the unit so that there are six (6) fabric panels per unit. Each fabric panel may be about 14 inches by 18 inches and include 2 layers of fabric treated in accordance with the invention. Accordingly, there may be six (6) fabric panels per unit and several such SBS treatment units may be used in a room.

Referring to Drawing D, apparatus for preferably passively treating and alleviating SBS to improve indoor air quality is depicted in the form of a vertically upstanding array designated generally 100 that includes a frame designated generally 102 for supporting strips of air permeable, botanically based antimicrobial, biocidal fabric, where the strips of fabric are designated 14-1, 14-2, 14-3, 14-4 and 14-5. Frame 102 supporting fabric strips 14-1 through 14-5 includes a plurality of upstanding members that are individually designated generally 104. Upstanding members 104 are categorized as first and second upstanding members 106, 108 that are connected front to back by bracing members 110.

Extending laterally between pairs of bracing members 110 and being a part of frame 102 are lateral members 112. In Drawing D, only certain ones of upstanding members 104, first and second upstanding members 106, 108, bracing members 110, and lateral members 112 have been numbered in order to maintain drawing clarity.

Further provided as a portion of frame 102 are cross-braces 114 desirably located at the top of pairs of second upstanding members 108 to increase lateral stability.

A given pair of first and second upstanding members 106, 108 can serve as parts of two adjacent upstanding portions 118 of frame 102 where frame 102 may comprise a number of such adjacent upstanding portions such as five such portions as illustrated in Drawing D. Two such upstanding portions 118 are indicated and so-designated in Drawing D.

Drawing G illustrates, in vertically truncated form, a broken segment of one of upstanding portions 118. In Drawing G, vertically upstanding members 106 and 108 are positioned at the corners of an imaginary rectangle, where the rectangle is illustrated in dotted lines and designated 120. The one of first upstanding members 106 at the left hand front side of the rectangle 120 is designated 106L in Drawing G, while the one of first upstanding members 106 at the right hand side of rectangle 120 is designated 106R in Drawing G. Similarly, the one of second upstanding members 108 at the left hand side of rectangle 120 is designated 108L in Drawing G and the one of second upstanding members 108 located at the right hand side of rectangle 120 is designated 108R. Upstanding members 106L and 106R are considered to define the front of rectangle 120 where rectangle 120 is provided in this disclosure to clarify the geometry of the structure illustrated in Drawing G.

There may optionally be provided first and second horizontally-oriented support members that are positionable on a floor or other surface to provide vertical support for upstanding portion 118 illustrated in Drawing G; these optionally horizontally-oriented support members would run along the respective dotted lines designated 122L and 122R of rectangle 120 in Drawing G.

As further illustrated in Drawing G, a plurality of vertically-spaced apart parallel bracing members 110 connect respective ones of the upstanding first and second members 106, 108 along respective sides of rectangle 120. Bracing members 100 are preferably provided and oriented in closely vertically-spaced, adjacent pairs as illustrated by parallel bracing members 110′, 110″ in Drawing G.

A plurality of lateral members 112 extend between and preferably slideably engage the vertically correspondingly positioned pairs 110′, 110″ of the horizontally-extending parallel bracing members 110. One such lateral member is indicated as 112 in Drawing G. There is further provided a lateral member in the form of a cross-brace 114 at the top of each upstanding portion 118 where the cross-brace 114 is illustrated in Drawing D.

Air permeable, antimicrobial, preferably botanically based, biocidal fabric, provided in the form of a strip 14-1 as illustrated in Drawing G, is connected at the top of the strip either to an uppermost one of lateral members 112 or to fixed lateral bracing member 114. Fabric strip 14-1 extends downwardly as illustrated in Drawing G and may be positioned in various configurations by adjusting position of lateral members 112 with fabric strip 14-1 passing on a selected side of a given lateral member 112 thereby to provide the desired configuration for fabric strip 14-1. Specifically, lateral members 112 are moveably positionable along the pairs of parallel bracing members 110, between front and rear with respect to rectangle 120, to cause fabric portions 14-1 connected to the lateral members and extending between the lateral members to conform to selected contours. Desirably, a portion of the selected contour or all of the selected contour may approximate the upper surface of an air foil, in response to positioning of lateral members 112 and in response to air blowing thereagainst or therealong. Positioning of fabric strip 14-1 as the upper surface of an air foil facilitates generation of vortices along the air foil-like surface, thereby contributing to greater air flow through and along fabric strip 14-1, enhancing the antimicrobial, biocidal effects of fabric 14-1.

Optionally, a fixed horizontal brace illustrated as 124 may be provided at the bottom of Drawing G with a fan 126 mounted thereon to blow air upwardly against and along fabric strip 14-1 as indicated by arrows 128 at the top of Drawing G.

Referring to Drawing E, the array 100A shown therein is similar to the array 100 illustrated in Drawing D and is constructed using segments as illustrated in Drawing G. In Drawing E, the upstanding portions 118 illustrated in Drawing G have been horizontally offset one from another front to back, relative to rectangles 120, thereby to provide a different and possibly more efficient configuration for array 100A. Other than the front to back offset of upstanding portions 118, array 100A in Drawing E is largely the same as array 100 illustrated in Drawing D, as can be seen by comparing the drawings in which functionally equivalent and substantially corresponding parts have the same number, with the letter “A” used to distinguish parts illustrated in Drawing E from functionally identical or similar corresponding parts in Drawing D.

With respect to array 100A illustrated in Drawing E, a single first upstanding member 106A could not serve as support for adjacent upstanding portions 118A due to the horizontal offset of the upstanding portions 118A as illustrated in Drawing E. However, a first upstanding member 106A of one upstanding portion 118A could serve as a second or rear upstanding member 108A of an adjacent upstanding portion 118A to horizontally offset as illustrated in Drawing E.

Referring to Drawings F and H, Drawing F illustrates another apparatus for improving indoor air quality in the form of an array 100B where array 100B includes a frame 102B that has vertically upstanding members 104B positioned at the corners of an imaginary rectangle with one edge of the rectangle being considered the front, in much the same manner as illustrated for Drawings D and G. Further similarly to Drawings D and G, one pair of upstanding members 104B has a first member 106B at the right front of the rectangle and a second member 108B at the right rear of the rectangle, and a second pair of upstanding members 104B having a first member at the left front of the rectangle and second member at the left rear of the rectangle where the members are designated 106B-L, 106B-R, 108B-L and 108B-R, with these designations being most clearly shown in Drawing H. In array 100B illustrated in Drawing F and in Drawing H, there are further provided a plurality of vertically-spaced apart bracing members 110B connecting respective ones of the upstanding first and second members 106B, 108B of the respective pairs of upstanding members 106B along respective sides of the imaginary rectangle. The imaginary rectangle is not illustrated in Drawing F nor in Drawing G to enhance drawing clarity.

As further illustrated in Drawing F, the air permeable, antimicrobial, botanically based, morbidity-inducing fabric is not provided in the form of vertically elongated strips that extend from the top to the bottom of the apparatus 100B. Rather, the air permeable, antimicrobial, botanically based, morbidity-inducing fabric is provided in the form of rectangular sheets 14B where rectangular sheets 14B may be provided as several sheets, one above another, in each upstanding portion 118B of apparatus 100B. Fabric sheets 14B may be secured directly to bracing members 110B desirably by unnumbered rings fitting around bracing members 110B, thereby permitting movement of a fabric sheets 14B between forward upstanding members 106B-L and 106B-R and rear upstanding members 108B-L and 108B-R. Alternatively, lateral members 112B may be provided at either the top or the bottom or both of fabric sheet 14B with lateral members 112B desirably being movable between front and rear along bracing members 110B. With this arrangement, fabric sheets 14B can be adjusted to assume any of a plurality of configurations to take advantage of natural convention in the room in which array 100B is located.

The inventive fabrics are effective microbicidal agents against environmentally and clinically important gram positive bacteria and molds. The mode of coupling of biocidal agents to the fabrics has not yet been fully determined, but the biocidal materials in accordance with the invention share a number of common features which may explain their passage into the microbial cell. Firstly, both gram positive bacteria and molds consist of thick resilient walls through which agents typically enter through passive diffusion. Both walls consist are relatively simple in construct; gram positive bacteria are primarily peptide chains linked by N-acetyl amino sugars (N-acetylglucosamine and N-acetylglutamic acid). In the mold cell wall these structures are replaced by a chitin backbone linked to either chitosan, glucan or mannan, depending on the mold. The preferred biocide, eugenol, is also effective against Mycobacterium smegmatis, which has a cell wall consisting of a mycolic acid containing arabinogalactan, suggesting the target molecule may be a sugar moiety (glucan/galactan).

In addition to evaluating efficacy of the treated fabrics, the treated fabrics were evaluated to determine if the treatments affected important fabric properties. Fabrics were evaluated to determine how their strength and drape changed with application of the natural antimicrobial biocidals. Tolerable decreases in fabric strength and crease recovery were noted as biocidal concentration increased. Bending length was not significantly affected by any of the treatments, indicating that the fabric stiffness was not altered by processing. Additionally, methods of washing the treated fabrics were evaluated with regards to whether washing treatments altered the antimicrobial efficacy of the fabric. Antimicrobial retention of the antimicrobially, biocidally most effective fabric was evaluated and found to be retained after being washed and rinsed in cold, warm or hot water followed by rinsing in cold water using method AATCC 147-1998, full retention of activity also occurred after a cold wash and rinse.

One very preferable fabric for use in practice of the invention is a substantially natural one (cotton/cotton-polyester); this fabric when treated with eugenol is effective for at least a month without surface cleaning and is able to be safely laundered using cold water without loss of activity.

In practice of the invention, eugenol is the preferable antimicrobial, naturally occurring biocide to be used in treating fabrics in accordance with the invention. However, eugenol is not the only antimicrobial, naturally occurring biocide that may be used in the practice of the invention. Other suitable antimicrobial, naturally occurring biocides are as set out above.

While eugenol is sometimes called “clove oil” because it is the active element in cloves, eugenol is an allyl chain-substituted guaiacol (2-methoxyphenol).

Oil extracted from cloves, which is sometimes called “eugenol” herein, has been found by Applicants to be much more effective as antimicrobial biocide than ordinary commercially available eugenol. Specifically, Applicants have found that it takes about five times as much commercially available eugenol to produce the same antimicrobial biocidal effect as clove oil extracted directly from cloves. Applicants have further found that calendula and chamomile are required to be used at least a 5% concentration in solution to be effective. Clove oil at a 0.1% concentration is an effective antimicrobial biocidal, as is eugenol at a 0.5% concentration. Aloe vera, if used, must be used at a 5% concentration.

The following is claimed:

1) A method for treating fabric to impart antimicrobial, biocidal properties thereto, comprising the steps of:
a) preparing an aqueous solution of a naturally occurring substance having antimicrobial properties;
b) applying the aqueous solution to the fabric to achieve a desired amount of solution pickup;
c) drying the fabric; and
d) curing the fabric.

2) The method of claim 1 wherein the naturally occurring substance is selected from the group consisting of echinacea, calendula, aloe vera, turmeric, chamomile, cloves and eugenol.

3) The method of claim 1 wherein the fabric includes at least one of cotton and rayon.

4) The method of claim 1 wherein the aqueous solution is applied to the fabric by padding the fabric with the solution.

5) A method for imparting antimicrobial, biocidal properties to fabric including cotton, rayon or both, comprising the steps of:
a) preparing an aqueous solution consisting of between about 5 and about 15 grams of eugenol per liter of solution, between about 5 and about 10 grams of polyvinyl alcohol per liter of solution and about 100 grams per liter of glyoxal per liter of solution;
b) applying the aqueous solution to the fabric to achieve about 65 percent by weight solution pickup;
c) drying the fabric at between about 80° and about 85° C. for about 4 minutes;
d) curing the fabric at between about 120° C. and about 140° C. for between about 3 and about 5 minutes.

6) The method of claim 5 wherein the solution is applied to the fabric by padding the fabric with the solution.

7) An antimicrobial fabric including a biocidally effective amount of a substance selected from the group consisting of echinacea, calendula, aloe vera, turmeric, chamomile, cloves and eugenol.

8) The fabric of claim 5 wherein the fabric includes at least one of cotton and rayon.

9) A method for combating sick building syndrome, comprising:
a) providing a plenum that is at least partially bounded by antimicrobial fabric including a biocidally effective amount of a substance selected from the group consisting of echinacea, calendula, aloe vera, turmeric, chamomile, cloves and eugenol; and
b) introducing air from an area manifesting sick building syndrome into the plenum for passage outwardly through the fabric into the area manifesting sick building syndrome.

10) A method for combating sick building syndrome, comprising:
a) providing antimicrobial fabric, including a biocidally effective amount of a substance selected from the group consisting of echinacea, calendula, aloe vera, turmeric, chamomile, cloves and eugenol, affixed across a frame; and
b) blowing air taken from an area manifesting sick building syndrome through a portion of the fabric affixed across the frame into the area manifesting sick building syndrome.

11) A modular unit for improving indoor air quality, comprising:
a) a frame surrounding an open interior and defining the outer periphery of the unit;
b) air permeable, antimicrobial fabric comprising a biocidally effective amount of a substance selected from the group consisting of echinacea, calendula, aloe vera, turmeric, chamomile, cloves and eugenol, secured about the frame periphery on a first side of the frame and covering the open interior on a first side of the frame;
c) an air impermeable member secured about and covering the frame periphery on a remaining side of the frame;
d) at least one aperture formed in the frame and being adapted to house a fan therein;
e) a fan housed in the aperture for blowing air from outside the frame into the frame interior for subsequent passage of air blown into the frame interior outwardly through the fabric.

12) Apparatus for combating sick building syndrome, comprising:
a) a plenum at least partially bounded by fabric comprising a biocidally effective amount of a substance selected from the group consisting of echinacea, calendula, aloe vera, turmeric, chamomile, cloves and eugenol; and
b) a fan for introducing air into the plenum for passage outwardly through the fabric.

13) Apparatus for combating sick building syndrome, comprising:
a) fabric comprising a biocidally effective amount of a substance selected from the group consisting of echinacea, calendula, aloe vera, turmeric, chamomile, cloves and eugenol; and
b) a frame adapted for affixation of the fabric thereacross; and
c) a fan for blowing air through a portion of the fabric affixed across the frame.

14) A modular unit for improving indoor air quality, comprising:
a) a frame surrounding an open interior and defining the outer periphery of the unit;
b) air permeable fabric including cotton, rayon or both, treated to be antimicrobial and biocidal by:
1) preparing an aqueous solution consisting of between about 5 and about 15 grams of eugenol per liter of solution, between about 5 and about 10 grams of polyvinyl alcohol per liter of solution and about 100 grams per liter of glyoxal per liter of solution;
2) applying the aqueous solution to the fabric to achieve about 65 percent by weight solution pickup;
3) drying the fabric at between about 80° and about 85° C. for about 4 minutes;
4) curing the fabric at between about 120° C. and about 140° C. for between about 3 and about 5 minutes.
c) an air impermeable member secured about and covering the frame periphery on a remaining side of the frame;
d) at least one aperture formed in the frame and being adapted to house a fan therein;
e) a fan housed in the aperture for blowing air from outside the frame into the frame interior for subsequent passage of air blown into the frame interior outwardly through the fabric.

15) Apparatus for combating sick building syndrome, comprising:
a) a plenum at least partially bounded by fabric including cotton, rayon or both, treated to be antimicrobial and biocidal by:
1) preparing an aqueous solution consisting of between about 5 and about 15 grams of eugenol per liter of solution, between about 5 and about 10 grams of polyvinyl alcohol per liter of solution and about 100 grams per liter of glyoxal per liter of solution;
2) applying the aqueous solution to the fabric to achieve about 65 percent by weight solution pickup;
3) drying the fabric at between about 80° and about 85° C. for about 4 minutes;
4) curing the fabric at between about 120° C. and about 140° C. for between about 3 and about 5 minutes; and
5) a fan for introducing air into the plenum for passage outwardly through the fabric.

16) Apparatus for combating sick building syndrome, comprising:
a) fabric including cotton, rayon or both, treated to be antimicrobial and biocidal by:
1) preparing an aqueous solution consisting of between about 5 and about 15 grams of eugenol per liter of solution, between about 5 and about 10 grams of polyvinyl alcohol per liter of solution and about 100 grams per liter of glyoxal per liter of solution;
2) applying the aqueous solution to the fabric to achieve about 65 percent by weight solution pickup;
3) drying the fabric at between about 80° and about 85° C. for about 4 minutes;
4) curing the fabric at between about 120° C. and about 140° C. for between about 3 and about 5 minutes;
5) a frame adapted for affixation of the fabric thereacross; and
6) a fan for blowing air through a portion of the fabric affixed across the frame.

17) A method for combating sick building syndrome comprising blowing air through an antimicrobial fabric including a biocidally effective amount of a substance selected from the group consisting of echinacea, calendula, aloe vera, turmeric, chamomile, cloves and eugenol.

18) A method for combating sick building syndrome comprising positioning for convective air flow thereagainst an antimicrobial fabric including a biocidally effective amount of a substance selected from the group consisting of echinacea, calendula, aloe vera, turmeric, chamomile, cloves and eugenol.

19) A method for combating sick building syndrome, comprising positioning at least one sheet of antimicrobial fabric that includes a biocidally effective amount of a substance selected from the group comprising echinacea, calendula, aloe vera, turmeric, chamomile, cloves and eugenol, in an area manifesting symptoms of sick building syndrome, oriented with the plane of the fabric extending more vertically than horizontally for convective air flow therealong.

20) The method of claim 19 wherein the fabric sheet has upper and lower extremities that are adjustably positionable respecting one another.

21) The method of claim 20 wherein the fabric upper and lower extremities have portions that are adjustably retained in position by a frame.

22) The method of claim 21 wherein the frame is upstanding.

23) A method for treating fabric including cotton, rayon or both, to impart antimicrobial properties thereto, comprising the steps of:
a) preparing an aqueous solution of eugenol, polyvinyl alcohol, and glyoxal;
b) padding the fabric with the aqueous solution to achieve a preselected desired part by weight wet pickup;
c) drying the fabric; and
d) curing the fabric.
